(19) United States
(12) Patent Application Publication
(10) Pub. No.: US 2026/0356170 A1
(43) Pub. Date: Nov. 12, 2026

(54) DUAL AIR VENT ASSEMBLY FOR A VEHICLE

(71) Applicant: Ford Global Technologies, LLC, Dearborn, MI (US)

(72) Inventors: Cesar Fernando Hernandez Olmos, Toluca (MX); Jorge Araujo Nieto, Toluca (MX); Jose Gerardo Velasco Macias, Mexico City (MX); Moises Alejandro Xolotl Cortes, Mexico City (MX); George David Koch Smith, Lake Orion, MI (US)

(73) Assignee: Ford Global Technologies, LLC, Dearborn, MI (US)

(21) Appl. No.: 19/202,546

(22) Filed: May 8, 2025

(51) Int. Cl. B60H 1/34

(52) U.S. Cl. CPC B60H 1/3421

(57) ABSTRACT

An air vent assembly includes an upper retainer and a lower retainer spaced from the upper retainer, a first outboard retainer and a second outboard retainer spaced from the first outboard retainer, wherein each of the first and second outboard retainers extends between the upper and lower retainers, and a center retainer extending between the upper and lower retainers and disposed between the first and second outboard retainers. A first vertical vane pack is disposed between the first outboard retainer and the center retainer, wherein the first vertical vane pack includes one or more vertical vanes pivotally coupled to both the upper and lower retainers, and a second vertical vane pack is disposed between the second outboard retainer and the center retainer, wherein the second vertical vane pack includes one or more vertical vanes pivotally coupled to both the upper and lower retainers.

### FIELD OF THE DISCLOSURE

The present disclosure generally relates to an air vent assembly for a vehicle, and specifically, to a dual air vent assembly for a vehicle.

### BACKGROUND OF THE DISCLOSURE

Air registers for vehicles typically include at least two subassemblies for each climate zone. Each subassembly is installed separately into the housing and includes numerous retainers for horizontal vane packs and vertical vane packs. This arrangement necessitates individual setups, jigs, and installation processes for each subassembly. Such air registers typically require numerous assembly steps and may require a significant amount of time to assemble. Furthermore, vehicular air registers generally have room for enhancement in robustness, rigidity, aerodynamics, functionality of components therein, and control over airflow therethrough. It is therefore desirable to enhance current vehicular air register designs by creating a more robust, rigid, and aerodynamic register capable of enhancing functionality of register components and airflow control.

### SUMMARY OF THE DISCLOSURE

According to a first aspect of the present disclosure, a dual air vent assembly includes an upper retainer, a lower retainer spaced from and extending along the upper retainer, wherein each of the upper and lower retainers defines at least one pivot well, a left outboard retainer extending between the upper and lower retainers, a right outboard retainer extending between the upper and lower retainers, and a center retainer extending between the upper and lower retainers and centered between the left and right outboard retainers. A first vertical vane pack is disposed between the left outboard retainer and the center retainer, and a second vertical vane pack is disposed between the right outboard retainer and the center retainer, wherein each of the first and second vertical vane packs includes a plurality of vertical vanes, wherein the plurality of vertical vanes of each of the first and second vertical vane packs are pivotal between a first closed position and a first fully articulated position, wherein the plurality of vertical vanes of the first vertical vane pack are independently pivotal relative to the plurality of vertical vanes of the second vertical vane pack, and wherein at least one of the plurality of vertical vanes of one of the first and second vertical vane packs is received by the at least one pivot well of each of the upper and lower retainers. A first airway is defined by the upper and lower retainers, the left outboard retainer, and the center retainer, wherein the first vertical vane pack is configured to laterally direct air passing through the first airway, and a second airway defined by the upper and lower retainers, the right outboard retainer, and the center retainer, wherein the second vertical vane pack is configured to laterally direct air passing through the second airway.

Embodiments of the first aspect of the present disclosure can include any one or a combination of the following features:
the upper and lower retainers, the left and right outboard retainers, and the center retainer are contained in a housing;
the dual air vent assembly further includes a first horizontal vane barrel pivotally coupled to the left outboard retainer and the center retainer adjacent to the first vertical vane pack and a second horizontal vane barrel pivotally coupled to the right outboard retainer and the center retainer adjacent to the first horizontal vane barrel, wherein each of the first and second horizontal vane barrels are pivotal between a second closed position and a second fully articulated position;
the center retainer defines a leading edge that divides an initial airway into the first airway and the second airway;
the first horizontal vane barrel is independently pivotal relative to the second horizontal vane barrel;
the first vertical vane pack is operably coupled to a first thumb gear, wherein the second vertical vane pack is operably coupled to a second thumb gear;
the first horizontal vane barrel includes a first outer horizontal vane, wherein the first outer horizontal vane extends between the upper and lower retainers and between the left outboard retainer and the center retainer in the second closed position, thereby substantially blocking airflow through the first airway;
the first horizontal vane barrel includes a first inner horizontal vane disposed between the first outer horizontal vane and the first vertical vane pack when the first horizontal vane barrel is in the second closed position, wherein the first inner horizontal vane is smaller than the first outer horizontal vane; and
the first outer horizontal vane defines an indent configured to enable air to pass through the first outer horizontal vane when the first horizontal vane barrel is in the second closed position.

According to a second aspect of the present disclosure, an air vent assembly includes an upper retainer and a lower retainer spaced from the upper retainer, a first outboard retainer and a second outboard retainer spaced from the first outboard retainer, wherein each of the first and second outboard retainers extends between the upper and lower retainers, and a center retainer extending between the upper and lower retainers and disposed between the first and second outboard retainers. A first vertical vane pack is disposed between the first outboard retainer and the center retainer, wherein the first vertical vane pack includes one or more vertical vanes pivotally coupled to both the upper and lower retainers, and a second vertical vane pack is disposed between the second outboard retainer and the center retainer, wherein the second vertical vane pack includes one or more vertical vanes pivotally coupled to both the upper and lower retainers, wherein at least one vertical vane of each of the first and second vertical vane packs is received by a first pivot well defined by the upper retainer and a second pivot well defined by the lower retainer, and wherein the second vertical vane pack is independently pivotal relative to the first vertical vane pack.

Embodiments of the second aspect of the present disclosure can include any one or a combination of the following features:
the first outboard retainer includes an outer wall extending between the upper and lower retainers and a body extending from the outer wall toward the center retainer;
the body defines an inner surface and a recessed surface that receives one of the one or more vertical vanes of the first vertical vane pack when the first vertical vane pack is in a fully articulated position;
a shutoff wall extends from the recessed surface, wherein one of the plurality of vertical vanes of the first vertical vane pack is overlapped by the shutoff wall when the first vertical vane pack is in a closed position;
the inner surface of the body is obliquely angled relative to the outer wall, wherein the inner surface is flush with one of the plurality of vertical vanes of the first vertical vane pack when the first vertical vane pack is in the fully articulated position; and
the center retainer includes a first rib extending between the upper retainer and the lower retainer and protruding toward the first outboard retainer, wherein one of the plurality of vertical vanes of the first vertical vane pack is configured to overlap the first rib when the first vertical vane pack is in a closed position.

According to a third aspect of the present disclosure, an air register for a vehicle includes a first vertical vane pack and a second vertical vane pack spaced from the first vertical vane pack, wherein each of the first and second vertical vane packs is pivotally coupled to an upper retainer and a lower retainer, and wherein the first vertical vane pack is independently pivotal relative to the second vertical vane pack. A first horizontal vane assembly is aligned with the first vertical vane pack and including a first outer horizontal vane configured to partially define a front register face and a first inner horizontal vane that is smaller than the first outer horizontal vane, wherein the first horizontal vane assembly is pivotal about a horizontal axis, and a second horizontal vane assembly is aligned with the second vertical vane pack and includes a second outer horizontal vane configured to partially define the front register face and a second inner horizontal vane that is smaller than the second outer horizontal vane, wherein the second horizontal vane assembly is pivotal about the horizontal axis, and wherein the second horizontal vane assembly is independently pivotal relative to the first horizontal vane assembly.

Embodiments of the third aspect of the present disclosure can include any one or a combination of the following features:
the air register further includes a first outboard retainer coupled to the upper and lower retainers and a center retainer spaced from the first outboard retainer and coupled to the upper and lower retainers, wherein the first horizontal vane assembly is pivotally coupled to the first outboard retainer and the center retainer;
the first vertical vane pack includes a plurality of vertical vanes, wherein one or more vertical vanes of the first vertical vane pack defines a ridge that extends toward the first horizontal vane assembly;
the first outboard retainer includes a body extending toward the center retainer, wherein the first outer horizontal vane of the first horizontal vane assembly is in close proximity to the body in a fully articulated position; and
the first outer horizontal vane of the first horizontal vane assembly is adjacent to the ridge of the one or more vertical vanes of the first vertical vane pack when the first horizontal vane assembly is in the fully articulated position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper side perspective view of a dual air vent assembly for a vehicle, the dual air vent assembly having a housing configured to be coupled to a vehicle panel and an air register disposed within the housing;

FIG. 2 is an exploded view of the dual air vent assembly;

FIG. 3 is an upper side perspective view of a left outboard retainer of the air register;

FIG. 4 is a top perspective view of a center retainer of the air register;

FIG. 5 is a top cross-sectional view of the dual air vent assembly including a first vertical vane pack in a first fully articulated position and a second vertical vane pack in a first fully articulated position;

FIG. 6 is a detailed cross-sectional view of a first airway of the dual air vent assembly, where the first vertical vane pack is in a first closed position;

FIG. 7 is a side cross-sectional view of a second airway of the dual air vent assembly, where a horizontal vane barrel is disposed in the second airway and is in a second fully extended position;

FIG. 8A is a side cross-sectional view of the dual air vent assembly, where a horizontal vane barrel is in a second closed position in the first airway;

FIG. 8B is a side cross-sectional view of the dual air vent assembly, where a horizontal vane barrel is in a second fully articulated position in the first airway;

FIG. 9 is a side cross-sectional upper perspective view of the horizontal vane barrel of the first airway in the second fully articulated position;

FIG. 10 is a top view of the dual air vent assembly having a first gear assembly and a second gear assembly;

FIG. 11 is a partially exploded perspective view of the first gear assembly;

FIG. 12 is a detailed lower side perspective view of the first airway;

FIG. 13 is a side cross-sectional view of the first gear assembly operably coupled to the housing;

FIG. 14 is a side cross-sectional view of a first gear of the first gear assembly fixedly coupled to a driver vane of the first vertical vane pack;

FIG. 15 is a partial top view of the first gear assembly including a second gear having a set of peripheral teeth interlocked with a set of peripheral teeth of a thumb gear of the first gear assembly;

FIG. 16 is a partial top view of the first gear assembly including the first gear having a set of peripheral teeth interlocked with a set of peripheral teeth of the second gear; and

FIG. 17 is an upper side perspective view of a horizontal vane barrel in the second closed position and including an outer horizontal vane aligned with a panel of a vehicle.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

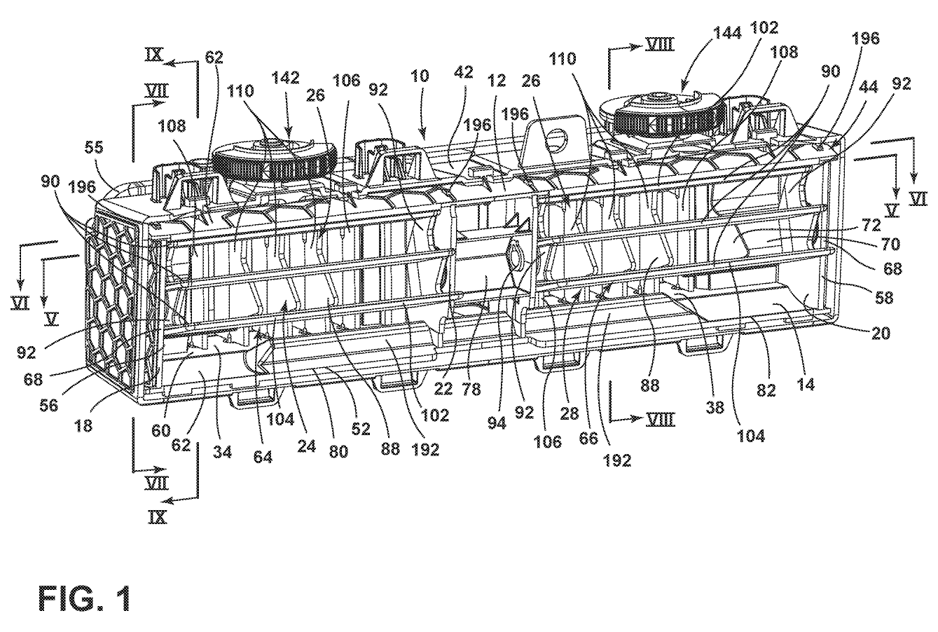

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an air vent assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

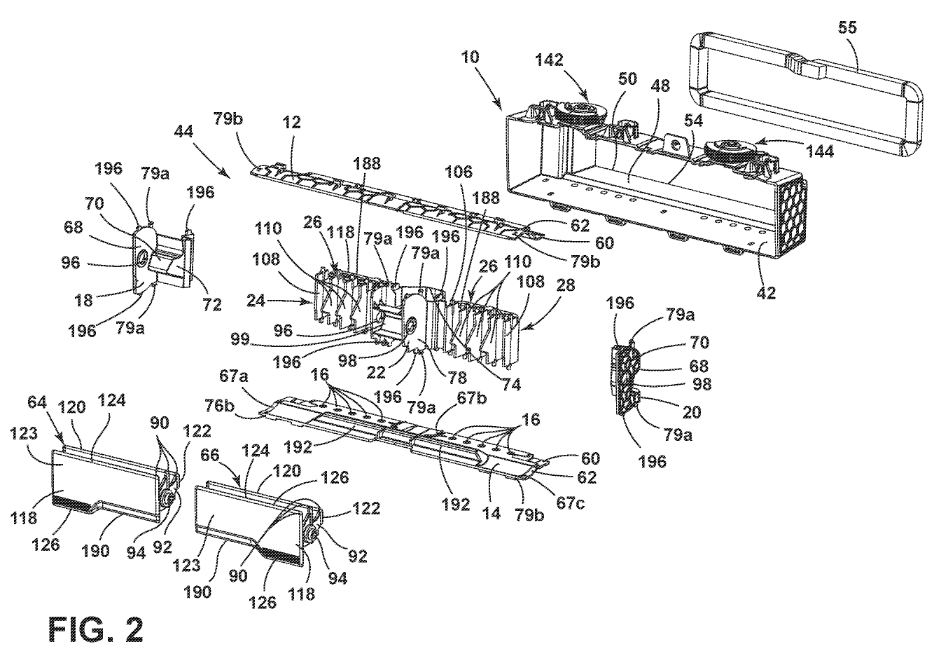

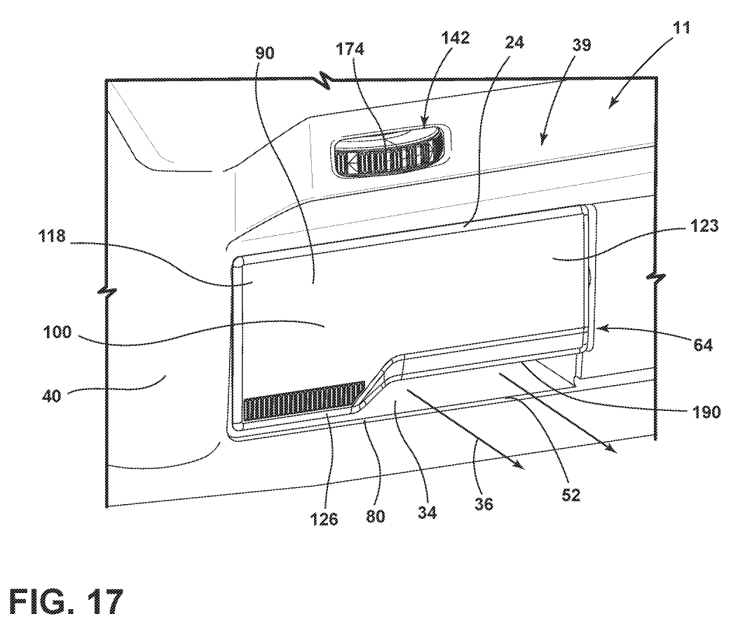

With reference to FIGS. 1 and 2, reference numeral 10 generally designates a dual air vent assembly for use on a motor vehicle 11 (FIG. 17). The dual air vent assembly 10 includes an upper retainer 12 and a lower retainer 14 spaced from and extending along the upper retainer 12. Each of the upper and lower retainers 12, 14 defines at least one pivot well 16. A left outboard retainer 18 extends between the upper and lower retainers 12, 14, and a right outboard retainer 20 extends between the upper and lower retainers 12, 14. A center retainer 22 is centered between the left and right outboard retainers 18, 20 and is coupled to both the upper and lower retainers 12, 14. A first vertical vane pack 24 has a plurality of vertical vanes 26 and is disposed between the left outboard retainer 18 and the center retainer 22, and a second vertical vane pack 28 has a plurality of vertical vanes 26 and is disposed between the right outboard retainer 20 and the center retainer 22, where each of the first and second vertical vane packs 24, 28 are pivotal between a closed position 30 (hereinafter “first closed position”) and a fully articulated position 32 (hereinafter “first fully articulated position”). Furthermore, the plurality of vertical vanes 26 of the first vertical vane pack 24 are independently pivotal relative to the plurality of vertical vanes 26 of the second vertical vane pack 28, and at least one of the plurality of vertical vanes 26 of one of the first and second vertical vane packs 24, 28 is received by the at least one pivot well 16 of each of the upper and lower retainers 12, 14. The dual air vent assembly 10 also includes a first airway 34 defined by the upper and lower retainers 12, 14, the left outboard retainer 18, and the center retainer 22, where the first vertical vane pack 24 is configured to laterally direct air 36 passing through the first airway 34. A second airway 38 is defined by the upper and lower retainers 12, 14, the right outboard retainer 20, and the center retainer 22, where the second vertical vane pack 28 is configured to laterally direct air 36 passing through the second airway 38.

With reference to FIGS. 1 and 17, the dual air vent assembly 10 is configured to be installed in an interior compartment 39 of the vehicle 11. The vehicle 11 may be a motor vehicle such as a wheeled motor vehicle having a motor such as an internal combustion engine, an electric battery powered motor, or a hybrid system having a combination of an internal combustion engine and an electric battery, for example. Particularly, the dual air vent assembly 10 may be incorporated into a panel 40 of the interior compartment 39 of the vehicle 11. It is contemplated that the panel 40 may be a vehicle dashboard panel, a front panel, a top panel, a bottom panel, a side panel, a rear panel, a panel of a center console, or another panel in the vehicle 11. The dual air vent assembly 10 may alternatively be incorporated into another vehicle component.

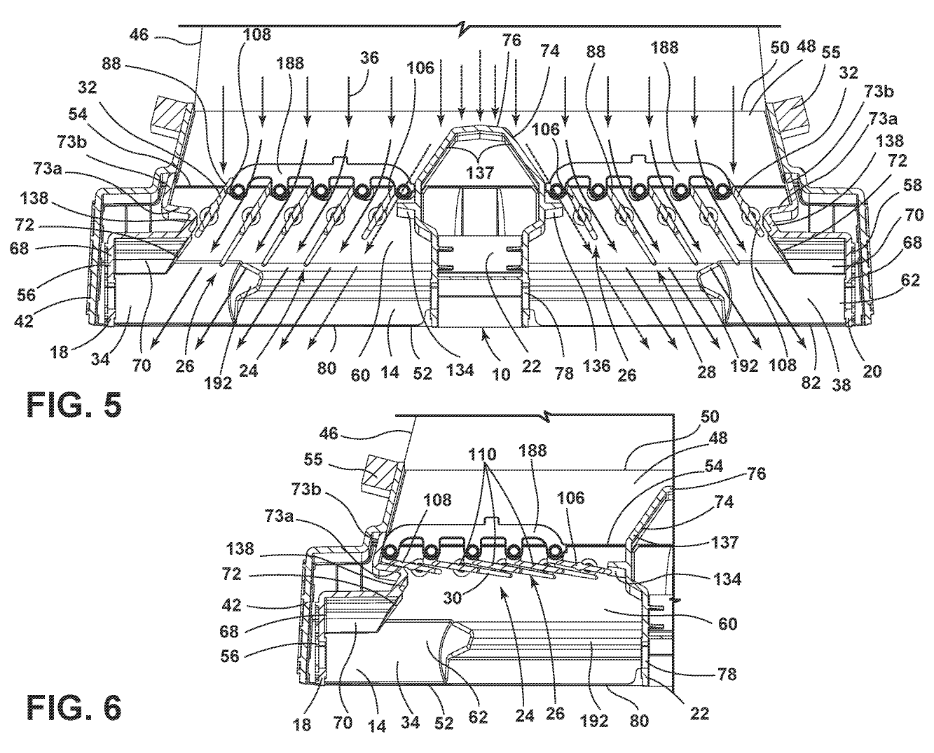

Referring to FIGS. 2 and 5, the dual air vent assembly 10 includes a housing 42 containing an air register 44 including the upper and lower retainers 12, 14, the left and right outboard retainers 18, 20, and the center retainer 22. The housing 42 is configured to couple to the panel 40 of the vehicle 11 (FIG. 17) and an air duct 46 of an HVAC system of the vehicle 11, forming an initial airway 48 that extends from the air duct 46 through an inlet 50 of the housing 42. The air register 44 defines a register opening 52 through which air 36 may exit the air register 44. The HVAC system of the vehicle 11 is operable between an active state and an inactivated state. When the HVAC system is in the activated state, the HVAC system causes air 36 to move through the air duct 46 toward the air register 44, through the inlet 50 of the housing 42, through the air register 44, out the register opening 52, and into the interior compartment 39 of the vehicle 11. According to some aspects, the housing 42 may have a variety of different constructions such that the dual air vent assembly 10 may be coupled to a variety of vehicle and panel types. It is also contemplated that the air duct 46 may be coupled to the air register 44 directly, and the initial airway 48 may be wholly defined by the air duct 46. The inlet 50 of the housing 42 is coupled to the air duct 46 with sealing foam 55. In some configurations, the housing 42 may alternatively be coupled to the air duct 46 via fasteners, adhesive material, and/or sealing tape, for example.

With reference to FIGS. 1-3, the air register 44 includes the upper retainer 12 and the lower retainer 14 extending along the upper retainer 12 in a spaced relationship with the upper retainer 12, where the upper and lower retainers 12, 14 extend between a left end 56 of the air register 44 and a right end 58 of the air register 44. Each of the upper and lower retainers 12, 14 is snappingly coupled to the housing 42, and each of the upper and lower retainers 12, 14 includes a vertical vane portion 60 and a horizontal vane portion 62. Together, the vertical vane portions 60 contain the first and second vertical vane packs 24, 28, and the horizontal vane portions 62 together contain a first horizontal vane assembly such as a first horizontal vane barrel 64 and a second horizontal vane assembly such as a second horizontal vane barrel 66. The horizontal vane portions 62 of the upper and lower retainers 12, 14 are curved outward so as to increase the space between the upper and lower retainers 12, 14 and enable pivoting of the first and second horizontal vane barrels 64, 66 about a horizontal axis relative to the air register 44. Each of the upper and lower retainers 12, 14 define a left pocket 67a, a center pocket 67b, and a right pocket 67c configured to receive the left outboard retainer 18, the center retainer 22, and the right outboard retainer 20, respectively, when the upper and lower retainers 12, 14 are snappingly coupled to the left outboard retainer 18, the center retainer 22, and the right outboard retainer 20. The left, center, and right pockets 67a, 67b, 67c define a shape corresponding to the bottom profile of the left outboard retainer 18, the center retainer 22, and the right outboard retainer 20, respectively, and provide lateral support for the left outboard retainer 18, the center retainer 22, and the right outboard retainer 20, respectively, against external loads applied to the air register 44, including lateral loads. In some instances, the left, center, and right pockets 67a, 67b, 67c may define an alternative shape and may be supplemented or substituted with flanges extending from the upper retainer 12 and/or the lower retainer 14 to provide further support against lateral movement of the left outboard retainer 18, the center retainer 22, and the right outboard retainer 20.

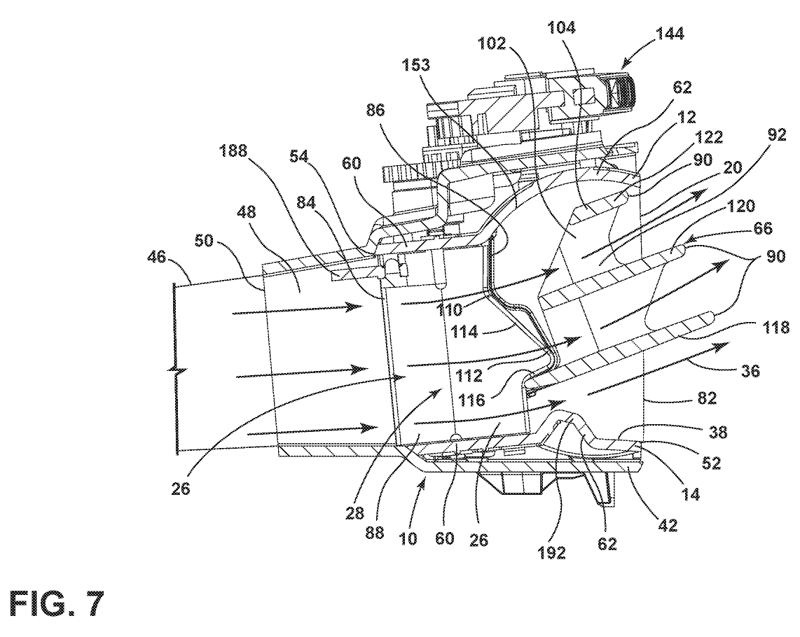

Referring to FIGS. 1, 2, 7, and 12, each of the vertical vane portions 60 of the upper and lower retainers 12, 14 defines a plurality of pivot wells 16 that each receive one of the plurality of vertical vanes 26 of the first vertical vane pack 24 or the second vertical vane pack 28. As illustrated, each except for one of the plurality of vertical vanes 26 of each of the first vertical vane pack 24 and the second vertical vane pack 28 is pivotally coupled to one pivot well 16 of the upper retainer 12 and one pivot well 16 of the lower retainer 14. Notably, the upper and lower retainers 12, 14 extend between the upstream side 54 of the air register 44 and the register opening 52. The housing 42 is stepped at the upstream side 54 of the air register 44 such that the vertical vane portion 60 of each of the upper and lower retainers 12, 14 is flush with the housing 42 at the upstream side 54 of the air register 44. According to some aspects, the horizontal vane portions 62 of the upper and lower retainers 12, 14 may be substantially planar and spaced from each other so as to enable pivoting of the first and second horizontal vane barrels 64, 66 about a horizontal axis relative to the air register 44. It is also contemplated that the pivot wells 16 may extend through each of the vertical vane portions 60 of the upper and lower retainers 12, 14, and the housing 42 may additionally define one or more pivot wells 16 above the upper retainer 12 and one or more pivot wells 16 below the lower retainer 14 that are configured to receive one or more of the plurality of vertical vanes 26 of the first vertical vane pack 24 and/or the second vertical vane pack 28.

With reference to FIGS. 1-3, each of the left and right outboard retainers 18, 20 includes an outer wall 68 and a body 70 extending from the outer wall 68, where the body 70 defines an inner surface 72. The outer wall 68 of the left outboard retainer 18 extends between the upper and lower retainers 12, 14 proximate the left end 56 of the air register 44, and the body 70 of the left outboard retainer 18 extends toward the center retainer 22. The right outboard retainer 20 has a generally mirrored construction relative to the left outboard retainer 18. The outer wall 68 of the right outboard retainer 20 extends between the upper and lower retainers 12, 14 proximate the right end 58, and the body 70 of the right outboard retainer 20 extends toward the center retainer 22. Both the left and right outboard retainers 18, 20 are snappingly coupled to each of the upper and lower retainers 12, 14. Each of the left and right outboard retainers 18, 20 further extends between the upstream side 54 of the air register 44 and the register opening 52, extending along both the vertical vane portion 60 and the horizontal vane portion 62 of each of the upper and lower retainers 12, 14. Accordingly, the left and right outboard retainers 18, 20 are in contact with the upper and lower retainers 12, 14 over an increased contact area compared to known outboard retainers, thereby increasing the resistance of the dual air vent assembly 10 to external forces applied to the air register 44.

Furthermore, the inner surface 72 of the left outboard retainer 18 is adjacent to the first vertical vane pack 24 such that the first vertical vane pack 24 is disposed between the body 70 of the left outboard retainer 18 and the center retainer 22. Similarly, the inner surface 72 of the right outboard retainer 20 is adjacent to the second vertical vane pack 28 such that the second vertical vane pack 28 is disposed between the body 70 of the right outboard retainer 20 and the center retainer 22. Each of the left and right outboard retainers 18, 20 additionally include a shutoff wall 73a extending away from the center retainer 22 and a retaining wall 73b extending from the shutoff wall 73a. The retaining walls 73b of each of the left and right outboard retainers 18, 20 align with the housing 42 at the upstream side 54 of the air register 44 such that each of the retaining walls 73b is flush with the housing 42 at the upstream side 54 (FIG. 5). The left and right outboard retainers 18, 20 are configured to receive the first and second horizontal vane barrels 64, 66, respectively. Alternatively, the left and right outboard retainers 18, 20 may accommodate horizontal vane assemblies having similar constructions to the first and second vertical vane packs 24, 28.

Referring to FIGS. 1, 2, and 4, the center retainer 22 extends between and is snappingly coupled to the upper and lower retainers 12, 14, the center retainer 22 being disposed between the left and right outboard retainers 18, 20 such that the center retainer 22 is centered therebetween. The center retainer 22 further extends along the upper and lower retainers 12, 14 between the upstream side 54 of the air register 44 and the register opening 52. The center retainer 22 includes a broad head 74 disposed between the first and second vertical vane packs 24, 28 and defining a leading edge 76, wherein the leading edge 76 protrudes from the upstream side 54 of the air register 44 toward the inlet 50 of the housing 42. The center retainer 22 further includes a broad base 78 disposed between the first and second horizontal vane barrels 64, 66 and extending between the head 74 and the register opening 52. At the leading edge 76, the initial airway 48 of the housing 42 forks into the first airway 34 and the second airway 38. Air 36 flowing through the initial airway 48 is substantially evenly distributed between the first and second airways 34, 38 when the first and second vertical vane packs 24, 28 are in the same position and the first and second horizontal vane barrels 64, 66 are in the same position. The center retainer 22 is in contact with the upper and lower retainers 12, 14 over an increased contact area compared to known center retainers, thereby increasing the resistance of the dual air vent assembly 10 to loads applied to the air register 44. Each of the center retainer 22 and the left and right outboard retainers 18, 20 includes a plurality of snap hooks 79a configured to snappingly engage attachment ports 79b of the upper and lower retainers 12, 14. The base 78 of the center retainer 22 is configured to receive the first and second horizontal vane barrels 64, 66. Alternatively, the center retainer 22 may accommodate horizontal vane assemblies having similar constructions relative to the first and second vertical vane packs 24, 28.

Referring to FIGS. 1 and 5, between the upstream side 54 of the air register 44 and the inlet 50 of the housing 42, the first airway 34 is defined by the housing 42 and the head 74 of the center retainer 22. Within the air register 44, the first airway 34 is defined by the upper and lower retainers 12, 14, the left outboard retainer 18, and the center retainer 22. Furthermore, between the upstream side 54 of the air register 44 and the inlet 50 of the housing 42, the second airway 38 is defined by the housing 42 and the head 74 of the center retainer 22. Within the air register 44, the second airway 38 is defined by the upper and lower retainers 12, 14, the right outboard retainer 20, and the center retainer 22. The first and second airways 34, 38 end at the register opening 52, and air 36 passing through the first and second airways 34, 38 pass through the register opening 52 after passing respectively through the first and second vertical vane packs 24, 28 and then respectively through the first and second horizontal vane barrels 64, 66. Specifically, the register opening 52 includes a first opening 80 and a second opening 82. The first opening 80 is defined by the upper and lower retainers 12, 14, the left outboard retainer 18, and the base 78 of the center retainer 22, while the second opening 82 is defined by the upper and lower retainers 12, 14, the right outboard retainer 20, and the base 78 of the center retainer 22. Accordingly, air 36 flowing through the first airway 34 exits through the first opening 80, and air 36 flowing through the second airway 38 exits through the second opening 82.

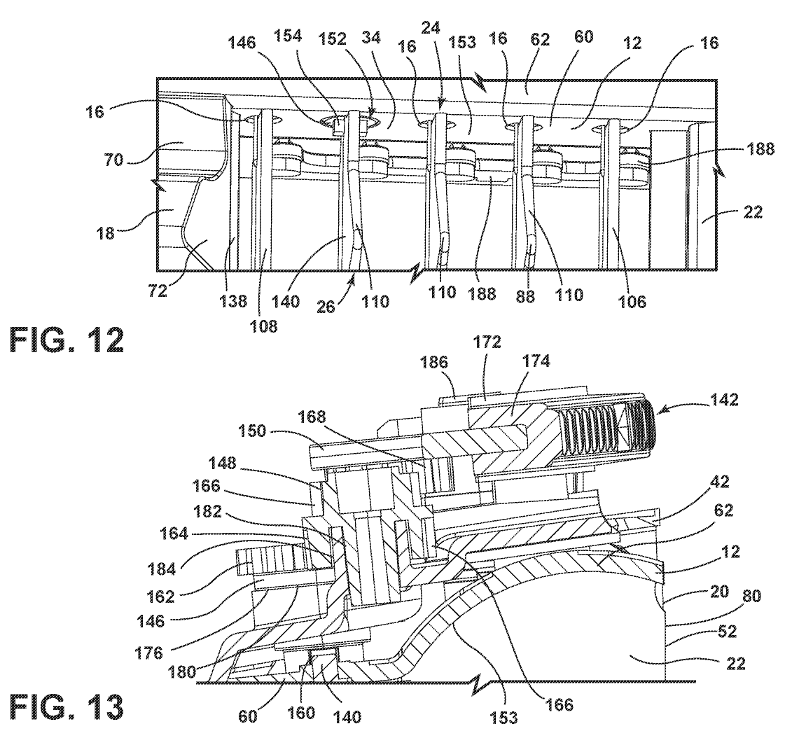

With reference to FIGS. 1, 2, 5, and 7, the dual air vent assembly 10 includes the first vertical vane pack 24 disposed in the first airway 34 and the second vertical vane pack 28 disposed in the second airway 38. The plurality of vertical vanes 26 of the first vertical vane pack 24 are oriented vertically and are evenly and transversely distributed across the first airway 34 between the left outboard retainer 18 and the center retainer 22. The plurality of vanes 26 of the vertical vane pack 24 each define an upstream edge 84 and a downstream edge 86. Furthermore, at least one of the plurality of vertical vanes 26 of the first vertical vane pack 24 is pivotally coupled to one of the plurality of pivot wells 16 defined by the upper retainer 12 (FIG. 12) and one of the plurality of pivot wells 16 defined by the lower retainer 14. Accordingly, each of the plurality of vertical vanes 26 of the first vertical vane pack 24 is pivotal about a distinct vertical axis between the first closed position 30 (FIG. 6) and the first fully articulated position 32 (FIG. 5). When the first vertical vane pack 24 is in the first closed position 30, each of the plurality of vanes 26 therein is laterally pivoted such that the downstream edge 86 is positioned closer to the center retainer 22 than the upstream edge 84, and each of the plurality of vanes 26 therein overlap or are overlapped by an adjacent one of the plurality of vanes 26, thereby substantially blocking any flow of air 36 through the first airway 34. When the first vertical vane pack 24 is in the first fully articulated position 32, each of the plurality of vanes 26 therein is laterally pivoted such that the upstream edge 84 is positioned closer to the center retainer 22 than the downstream edge 86, and each of the plurality of vanes 26 therein are angled so as to direct any air 36 flowing through the first airway 34 in a direction toward the first opening 80 and away from the center retainer 22.

The second vertical vane pack 28 is disposed in the second airway 38 between the right outboard retainer 20 and the center retainer 22 and has a mirrored configuration relative to the first vertical vane pack 24. At least one of the plurality of vertical vanes 26 of the second vertical vane pack 28 is pivotally coupled to one of the plurality of pivot wells 16 defined by the upper retainer 12 (FIG. 12) and one of the plurality of pivot wells 16 defined by the lower retainer 14. The second vertical vane pack 28 is pivotal independently from the first vertical vane pack 24, and the second vertical vane pack 28 is also operable between the first closed position 30 (FIG. 6) and the first fully articulated position 32 (FIG. 5). The first and second vertical vane packs 24, 28 are also operable between the first closed position 30 and a first open position 88, where the first open position 88 is any position that is not the first closed position 30, including the first fully articulated position 32.

Referring to FIGS. 1 and 2, the dual air vent assembly 10 also includes the first and second horizontal vane barrels 64, 66, where the first horizontal vane barrel 64 has a mirrored configuration relative to the second horizontal vane barrel 66. The first and second horizontal vane barrels 64, 66 each include a plurality of horizontal vanes 90 extending between a pair of side plates 92, where each of the plurality of horizontal vanes 90 is fixedly coupled to both of the pair of side plates 92. Further regarding each of the first and second horizontal vane barrels 64, 66, each of the pair of side plates 92 includes a shaft 94 extending therefrom. The pair of shafts 94 of the first horizontal vane barrel 64 are received by a first pair of pivot bores 96, respectively, where one of the first pair of pivot bores 96 is defined by the outer wall 68 of the left outboard retainer 18 and one of the first pair of pivot bores 96 is defined by the base 78 of the center retainer 22 such that the first horizontal vane barrel 64 is pivotal about a horizontal axis relative to the air register 44. The pair of shafts 94 of the second horizontal vane barrel 66 are received by a second pair of pivot bores 98, respectively, where one of the second pair of pivot bores 98 is defined by the outer wall 68 of the right outboard retainer 20 and one of the second pair of pivot bores 98 is defined by the base 78 of the center retainer 22 such that the second horizontal vane barrel 66 is pivotal about a horizontal axis relative to the air register 44.

The base 78 of the illustrated center retainer 22 is laterally broad such that the shafts 94 of the first and second horizontal vane barrels 64, 66 received by the base 78 are in a spaced relationship. Furthermore, the base 78 of the center retainer 22 includes a support gusset 99 extending at least partially around each of the pivot bores defined by the base 78, including one of the first pair of pivot bores 96 and one of the second pair of pivot bores 98. As a result, the rigidity of the center retainer 22 and the air register 44 are increased. It is contemplated that the first and second horizontal vane barrels 64, 66 may be pivotal about a common horizontal axis. Furthermore, one or each of the first and second horizontal vane barrels 64, 66 may be substituted with a horizontal vane assembly having a construction that is similar to the first and second vertical vane packs 24, 28.

With reference to FIGS. 1 and 7-8B, each of the first and second horizontal vane barrels 64, 66 are pivotal between a second closed position 100 and a second open position 102 such as a second fully articulated position 104. When the first horizontal vane barrel 64 is in the second closed position 100, each of the plurality of horizontal vanes 90 therein extends substantially transversely across the first airway 34, thereby at least partially blocking any air 36 from flowing through the first airway 34. When the first horizontal vane barrel 64 is in the second fully articulated position 104, each of the plurality of horizontal vanes 90 therein extends substantially along the first airway 34, and one or more of the plurality of horizontal vanes 90 therein extend out of the first opening 80. Similarly, when the second horizontal vane barrel 66 is in the second closed position 100, each of the plurality of horizontal vanes 90 therein extends substantially transversely across the second airway 38, thereby at least partially blocking any air 36 from flowing through the second airway 38. When the second horizontal vane barrel 66 is in the second fully articulated position 104, each of the plurality of horizontal vanes 90 therein extends substantially along the second airway 38, and one or more of the plurality of horizontal vanes 90 therein extend out of the second opening 82. In some instances, the plurality of horizontal vanes 90 of each of the first and second horizontal vane barrels 64, 66 are oriented at an oblique angle relative to the first and second airways 34, 38, respectively, when in the second fully articulated position 104. The second open position 102 of each of the first and second horizontal vane barrels 64, 66 is a position that is not the second closed position 100, including the second fully articulated position 104.

Referring to FIGS. 2-4, the plurality of vertical vanes 26 of each of the first and second vertical vane packs 24, 28 includes an inner vertical vane 106, an outer vertical vane 108, and a plurality of middle vertical vanes 110 disposed between the inner and outer vertical vanes 106, 108. Regarding the first vertical vane pack 24, the inner vertical vane 106 therein is disposed proximate the center retainer 22, and the outer vertical vane 108 therein is disposed proximate the left outboard retainer 18. Regarding the second vertical vane pack 28, the inner vertical vane 106 therein is disposed proximate the center retainer 22, and the outer vertical vane 108 therein is disposed proximate the right outboard retainer 20. The downstream edge 86 of each of the plurality of middle vertical vanes 110 of the first and second vertical vane packs 24, 28 defines a ridge 112 that increases control of air 36 flowing therethrough. The ridge 112 of each of the plurality of middle vertical vanes 110 of the first and second vertical vane packs 24, 28 extends toward the register opening 52 and defines an upper flank 114 and a lower flank 116.

With reference to FIGS. 1, 2, and 7-8B, each of the first and second horizontal vane barrels 64, 66 includes an outer horizontal vane 118, a middle horizontal vane 120, and an inner horizontal vane 122, where the middle horizontal vane 120 is disposed between the outer horizontal vane 118 and the inner horizontal vane 122. When the first and second horizontal vane barrels 64, 66 are in the second closed position 30, the outer horizontal vane 118 of the first horizontal vane barrel 64 is disposed at the first opening 80 of the register opening 52, and the outer horizontal vane 118 of the second horizontal vane barrel 66 is disposed at the second opening 82 of the register opening 52. Furthermore, when the first and second horizontal vane barrels 64, 66 are in the second closed position 30, the inner horizontal vane 122 of the first horizontal vane barrel 64 is disposed proximate the first vertical vane pack 24, and the inner horizontal vane 122 of the second horizontal vane barrel 66 is disposed proximate the second vertical vane pack 28. The outer horizontal vanes 118 substantially span the first opening 80 and the second opening 82, respectively, each partially defining a front face 123 (FIG. 17) of the dual air vent assembly 10, when the first and second horizontal vane barrels 64, 66 are in the second closed position 100. As such, the outer horizontal vanes 118 may be flush with, mimic, and/or include a similar finish relative to the panel 40 (FIG. 17) in which the dual air vent assembly 10 is incorporated.

Regarding the first and second horizontal vane barrels 64, 66, the outer horizontal vanes 118 are larger than the middle horizontal vanes 120 and the inner horizontal vanes 122. Furthermore, the middle horizontal vanes 120 are larger than the inner horizontal vanes 122. When the first and second horizontal vane barrels 64, 66 are in the second closed position 100, the inner horizontal vanes 122 are adjacent to the first and second vertical vane packs 24, 28, respectively, above the ridges 112 of the plurality of middle vertical vanes 110 of the first and second vertical vane packs 24, 28. Furthermore, when the first and second horizontal vane barrels 64, 66 are in the second closed position 100, the middle horizontal vanes 120 of the first and second horizontal vane barrels 64, 66 are disposed between the outer horizontal vanes 118 and the ridges 112 of the plurality of middle vertical vanes 110 of the first and second vertical vane packs 24, 28.

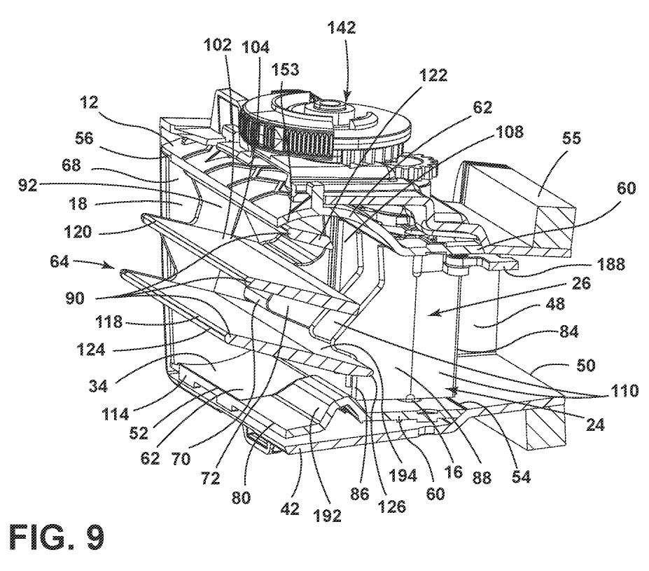

With reference to FIGS. 1, 2, and 7-9, when the first horizontal vane barrel 64 pivots from the second closed position 100 to the second fully articulated position 104, an upper edge 124 of the outer horizontal vane 118 of the first horizontal vane barrel 64 moves away from the first vertical vane pack 24, and a lower edge 126 of the outer horizontal vane 118 of the first horizontal vane barrel 64 moves toward the first vertical vane pack 24 until the lower edge 126 is situated adjacent to the lower flanks 116 of the ridges 112 of the plurality of middle vertical vanes 110 of the first vertical vane pack 24. Furthermore, when the first horizontal vane barrel 64 pivots from the second closed position 100 to the second fully articulated position 104, the middle and inner horizontal vanes 120, 122 of the first horizontal vane barrel 64 move closely along the curvature of the horizontal vane portion 62 of the upper retainer 12, while the lower edge 126 of the outer horizontal vane 118 of the first horizontal vane barrel 64 moves closely along the curvature of the lower retainer 14 until the lower edge 126 is situated adjacent to the body 70 of the left outboard retainer 18. The second horizontal vane barrel 66 is pivotal between the second closed position 100 and the second fully articulated position 104 in a similar manner relative to the first horizontal vane barrel 64.

During the operation of the first horizontal vane barrel 64 from the second closed position 100 to the second fully articulated position 104 and vice versa, the lower edge 126 of the outer horizontal vane 118 comes into close proximity with the lower retainer 14 and the body 70 of the left outboard retainer 18 and the middle and inner horizontal vanes 120, 122 come into close proximity with the upper retainer 12, effectively sealing the first airway 34 and maximizing airflow performance and control. In one exemplary operation, a user may operate the first horizontal vane barrel 64 from the second closed position 100 to the first fully articulated position 104 by applying a predetermined amount of force to the outer horizontal vane 118 therein proximate the lower edge 126. Conversely, the user may operate the first horizontal vane barrel 64 from the second fully articulated position 104 to the second closed position 100 by applying a predetermined amount of force to the outer horizontal vane 118 therein proximate the upper edge 124, for example. It is contemplated that the first horizontal vane barrel 64 may be alternatively or additionally electrically operated between the second closed position 100 and the second fully articulated position 104 with an electrical actuator in communication with a controller of the vehicle 11 (FIG. 17).

The second horizontal vane barrel 66 is pivotal from the second closed position 100 to the second fully articulated position 104 in the second airway 38 in a similar manner relative to the air register 44 as compared to the first horizontal vane barrel 64. According to some aspects, the outer horizontal vanes 118 may abut or be in close proximity to the body 70 and/or the lower flanks 116 of the middle vertical vanes 110 of one or each of the first and second vertical vane packs 24, 28 when the first and second horizontal vane barrels 64, 66 are in the second fully articulated position 104. As may also be applied to the second horizontal vane barrel 66, it is contemplated that the first horizontal vane barrel 64 may be pivoted from the second closed position 100 to an alternative fully articulated position where the upper edge 124 of the outer horizontal vane 118 moves toward the first vertical vane pack 24 until the upper edge 124 is situated adjacent to the upper flank 114 of the ridges 112 of the first vertical vane pack 24.

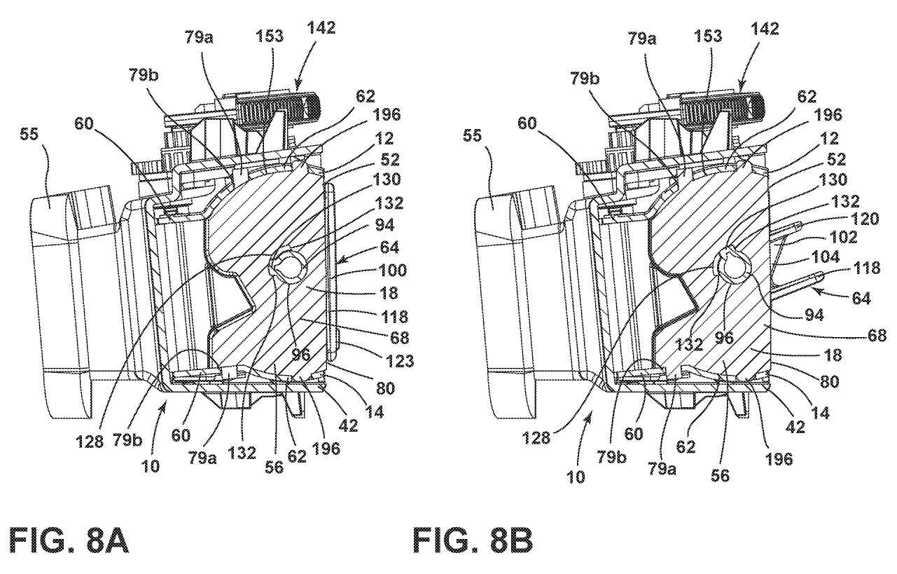

Referring to FIGS. 2, 8A, and 8B, the pivot range of the first horizontal vane barrel 64 between the second closed position 100 and the second fully articulated position 104 is controlled by the interaction between a recessed sector 128 defined by each of the first pair of pivot bores 96 and a projection 130 extending from each of the shafts 94 of the first horizontal vane barrel 64. When the first horizontal vane barrel 64 pivots between the second closed position 100 and the second fully articulated position 104, the shafts 94 of the first horizontal vane barrel 64 pivot within the first pair of pivot bores 96, respectively, causing the projections 130 of the shafts 94 of the first horizontal vane barrel 64 to move within the recessed sectors 128, respectively. Accordingly, bounds 132 of the recessed sectors 128 of the first pair of pivot bores 96 define the second closed position 100 and the second fully articulated position 104. When the first horizontal vane barrel 64 is in the second closed position 100, the projections 130 of each of the shafts 94 abut one of the bounds 132 of the recessed sectors 128 of the first pair of pivot bores 96. Similarly, when the first horizontal vane barrel 64 is in the second fully articulated position 104, the projections 130 of the shafts 94 abut the other one of the bounds 132 of the recessed sector 128 of the first pair of pivot bores 96. Notably, the second horizontal vane barrel 66 has a mirrored construction as compared to the first horizontal vane barrel 64 and may have a similar pivot range. In some instances, the second horizontal vane barrel 66 may have a different construction and/or a different pivot range.

With reference to FIGS. 4-6, the head 74 of the center retainer 22 includes a first rib 134 and a second rib 136 that are disposed on the head 74 between the leading edge 76 and the base 78. The head 74 is generally tapered from the first and second ribs 134, 136 toward the leading edge 76. Specifically, the head 74 includes a pair of air aiming surfaces 137, where one of the air aiming surfaces 137 extends between the leading edge 76 and the first rib 134 and one of the air aiming surfaces 137 extends between the leading edge 76 and the second rib 136. The first and second ribs 134, 136 generally extend between the upper and lower retainers 12, 14 and protrude into the first and second airways 34, 38, respectively. Furthermore, the first and second ribs 134, 136 of the center retainer 22 are laterally aligned with the plurality of pivot wells 16 defined by both the upper and lower retainers 12, 14 in the first and second airways 34, 38, respectively. As illustrated, the first and second ribs 134, 136 are tapered toward the left outboard retainer 18 and the right outboard retainer 20, respectively.

When the first vertical vane pack 24 is in the first closed position 30, the downstream edge 86 of the inner vertical vane 106 therein overlaps and abuts the first rib 134, thereby substantially blocking any air 36 from passing between the inner vertical vane 106 and the first rib 134. Similarly, when the second vertical vane pack 28 is in the first closed position 30, the downstream edge 86 of the inner vertical vane 106 therein overlaps and abuts the second rib 136, thereby substantially blocking any air 36 from passing between the inner vertical vane 106 and the second rib 136. When air 36 passes by the center retainer 22 from the initial airway 48 into the first and second airways 34, 38, the pair of air aiming surfaces 137 are configured to push the air 36 around the first and second ribs 134, 136, respectively, thereby minimizing airflow resistance within the first and second airways 34, 38, respectively. According to some aspects, the upstream edges 84 of the inner vertical vanes 106 of each of the first and second vertical vane packs 24, 28 may overlap and/or abut the first and second ribs 134, 136, respectively, when the first and second vertical vane packs 24, 28 are in the first fully articulated position 32. Alternatively, the downstream edges 86 of the inner vertical vanes 106 of the first and second vertical vane packs 24, 28 may be in a spaced relationship with the first and second ribs 134, 136, respectively, when the first and second vertical vane packs 24, 28 are in the first closed position 30 and/or the first fully articulated position 32.

With further reference to FIGS. 4-6, when the first vertical vane pack 24 is in the first closed position 30, the upstream edge 84 of the outer vertical vane 108 therein abuts and is overlapped by the shutoff wall 73a of the left outboard retainer 18, thereby substantially blocking any air 36 from passing between the outer vertical vane 108 and shutoff wall 73a. Similarly, when the second vertical vane pack 28 is in the first closed position 30, the upstream edge 84 of the outer vertical vane 108 therein abuts and is overlapped by the shutoff wall 73a of the right outboard retainer 20, thereby substantially blocking any air 36 from passing between the outer vertical vane 108 and shutoff wall 73a. According to some aspects, the upstream edges 84 of the outer vanes 108 of the first and second vertical vane packs 24, 28 may be in a spaced relationship with the shutoff walls 73a and/or the retaining walls 73b of the left and right outboard retainers 18, 20, respectively, when the first and second vertical vane packs 24, 28 are in the first closed position 30.

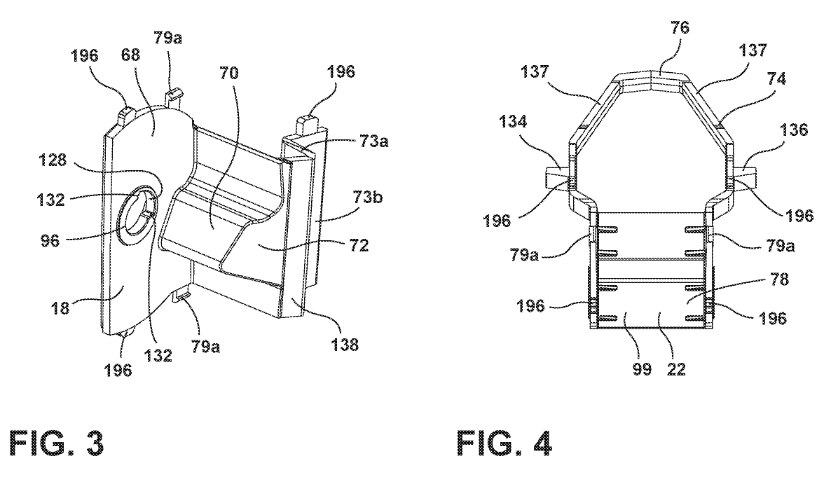

With reference to FIGS. 3, 5, and 6, the inner surfaces 72 of each of the left and right outboard retainers 18, 20 define a recessed surface 138. The recessed surface 138 of the left outboard retainer 18 receives the outer vertical vane 108 of the first vertical vane pack 24 in the first fully articulated position 32, and the recessed surface 138 of the right outboard retainer 20 receives the outer vertical vane 108 of the second vertical vane pack 28 in the first fully articulated position 32. When the recessed surface 138 of the left outboard retainer 18 receives the outer vertical vane 108 of the first vertical vane pack 24 in the first fully articulated position 32, the inner surface 72 of the left outboard retainer 18 is substantially flush with the outer vertical vane 108 of the first vertical vane pack 24. Similarly, when the recessed surface 138 of the right outboard retainer 20 receives the outer vertical vane 108 of the second vertical vane pack 28, the inner surface 72 of the right outboard retainer 20 is substantially flush with the outer vertical vane 108 of the second vertical vane pack 28. The alignment between the inner surfaces 72 of the left and right outboard retainers 18, 20 and the outer vanes 108 of the first and second vertical vane packs 24, 28, respectively, minimizes interference with air 36 passing through the air register 44 and thus reduces pressure drop along the HVAC system and the dual air vent assembly 10. Regarding the first vertical vane pack 24, the inner surface 72 of the left outboard retainer 18 defines a contour similar to the ridge 112 of each of the plurality of middle vertical vanes 110 of the first vertical vane pack 24, thereby promoting flow uniformity of air 36 passing through the first airway 34. Notably, the inner surface 72 of the right outboard retainer 20 has a mirrored contour relative to the inner surface 72 of the left outboard retainer 18.

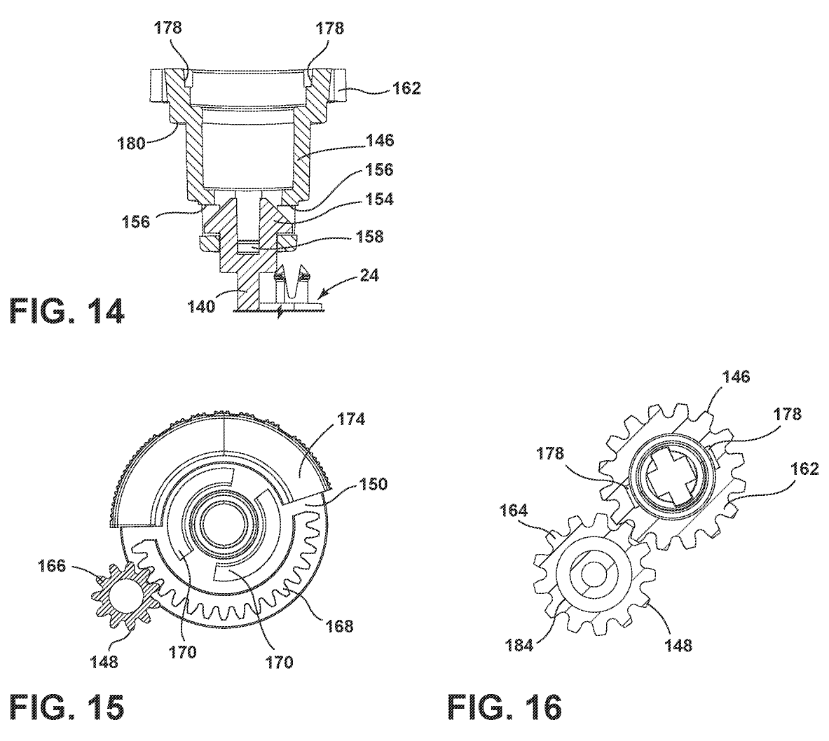

Referring now to FIGS. 2 and 10-14, one of the plurality of middle vertical vanes 110 of each of the first and second vertical vane packs 24, 28 is a driver vane 140. The driver vane 140 of the first vertical vane pack 24 is operably coupled to a first gear assembly 142, and the driver vane 140 of the second vertical vane pack 28 is operably coupled to a second gear assembly 144. The second gear assembly 144 has a mirrored configuration relative to the first gear assembly 142. Each of the first and second gear assemblies 142, 144 includes a first gear 146, a second gear 148, and a thumb gear 150. Each of the first gears 146 of the first and second gear assemblies 142, 144 is received by one of a pair of raised first gear ports 176 defined by the housing 42 and one of a pair of apertures 152 defined by the upper retainer 12. The pair of apertures 152 are situated proximate the left and right ends 56, 58 of the air register 44, respectively, and are fixedly coupled to the driver vanes 140 of the first and second vertical vane packs 24, 28, respectively. The pair of first gear ports 176 are aligned with the pair of apertures 152, respectively. Regarding each of the first and second gear assemblies 142, 144, the first gear 146 is received by one of the pair of apertures 152 such that the first gear 146 is substantially flush with an inside surface 153 of the upper retainer 12 (FIG. 12). The driver vane 140 of each of the first and second vertical vane packs 24, 28 includes a snap feature 154 extending therefrom. Regarding each of the first and second vertical vane packs 24, 28, the snap feature 154 of the driver vane 140 is received by the one or more snap windows 156 defined by the first gear 146 of one of the first and second gear assemblies 142, 144. Additionally, the driver vanes 140 of the air register 44 each include a pair of spaced torque protuberances 158. The pair of protuberances 158 extend respectively into a pair of torque channels 160 defined by each of the first gears 146 of the first and second gear assemblies 142, 144, effectively reducing torque-induced stress at the driver vane 140 and increasing overall robustness of the dual air vent assembly 10. The first gears 146 of the first and second gear assemblies 142, 144 are pivotal relative to the upper retainer 12, and the driver vanes 140 of the first and second vertical vane packs 24, 28 are also pivotally coupled to one of the plurality of pivot wells 16 defined by the lower retainer 14.

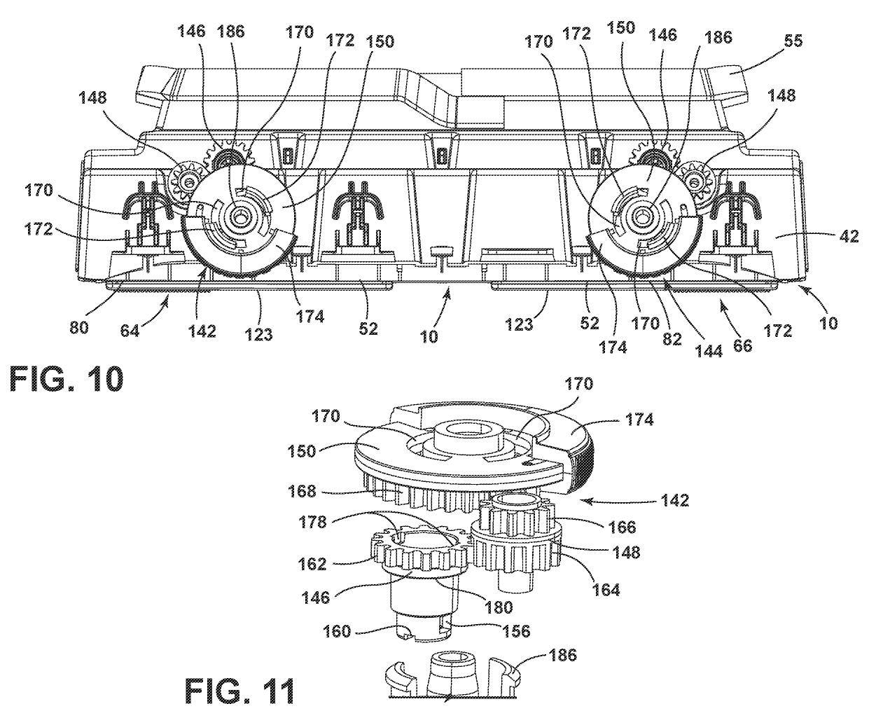

With reference to FIGS. 10-16, regarding each of the first and second gear assemblies 142, 144, the first gear 146 is pivotally coupled to the housing 42 and includes a first set of peripheral teeth 162 that are interlocked with a second set of peripheral teeth 164 of the second gear 148. The second gear 148 is pivotally coupled to the housing 42 and includes a third set of peripheral teeth 166 that is radially offset outward from the second set of peripheral teeth 164, which decreases a predetermined amount of force required for the user to pivot the thumb gear 150. The third set of peripheral teeth 166 of the second gear 148 are interlocked with a fourth set of peripheral teeth 168 of the thumb gear 150, where the thumb gear 150 is also pivotally coupled to the housing 42. Furthermore, the thumb gear 150 defines a pair of arcuate slots 170 extending along the periphery thereof within the fourth set of peripheral teeth 168. The pair of arcuate slots 170 receive a pair of stopper prongs 172 extending from the housing 42. When the thumb gear 150 is pivoted by the user, the pair of arcuate slots 170 pivot relative to the pair of stopper prongs 172 which limits the angular rotation of the thumb gear 150 such that the first and second vertical vane packs 24, 28 are pivotal between the first closed position 30 and the first fully articulated position 32. In some instances, the first and second sets of peripheral teeth 162, 164 may not be radially offset. Alternatively, the first set of peripheral teeth 162 may be radially offset outward relative to the second set of peripheral teeth 164. It is also contemplated that the first set of peripheral teeth 162 may define a thin, flat profile to reduce gear rocking of the first gear 146.

Regarding each of the first and second gear assemblies 142, 144, the first gear 146, the second gear 148, and the thumb gear 150 are vertically offset and at least partially laterally offset. The thumb gear 150 includes a thumb pad 174 extending partially along the periphery of the thumb gear 150. The thumb pad 174 is configured to be contacted by the user and pivoted after being subjected to the predetermined amount of force. When the thumb pad 174 is subjected to a force equal to or greater than the predetermined amount of force, the thumb gear 150 is rotated, thereby rotating the second gear 148, the first gear 146, and the driver vane 140 relative to the air register 44. The thumb pad 174 may protrude through the panel 40 of the vehicle 11 (FIG. 17) and/or the housing 42 such that the thumb pad 174 can be conveniently accessed by the user. According to some aspects, the first gear 146, the second gear 148, and/or the thumb gear 150 may be directly and pivotally coupled to the upper retainer 12. Alternatively, the first and second gear assemblies 142, 144 may be operably coupled to the first and second vertical vane packs 24, 28, respectively, at the lower retainer 14 in a configuration that mirrors or varies from the first and second gear assemblies 142, 144 illustrated in FIG. 10. Notably, the predetermined amount of force may vary based on the material composition of the housing 42 and the first and second gear assemblies 142, 144, the dimensions of the first, second, and thumb gears 146, 148, 150 of the first and second gear assemblies 142, 144, and the clearance between components of the housing 42 and each of the first and second gear assemblies 142, 144.

With reference to FIGS. 1, 2, and 10-16, according to one exemplary assembly sequence of the first gear assembly 142, a subassembly, including the upper and lower retainers 12, 14, the left and right outboard retainers 18, 20, the center retainer 22, the first and second vertical vane packs 24, 28, and the first and second horizontal vane barrels 64, 66, is disposed within the housing 42, where the snap feature 154 of the driver vane 140 of the first vertical vane pack 24 is disposed in the aperture 152 of the upper retainer 12 proximate the first vertical vane pack 24. The first gear 146 of the first gear assembly 142 is then pivotally coupled to the housing 42 and disposed within the aperture 152 through the first gear port 176 of the housing 42. Here, the snap windows 156 of the first gear 146 receive the snap feature 154 of the driver vane 140 of the first vertical vane pack 24 and the torque protuberances 158 of the driver vane 140 are received by the torque channels 160 of the first gear 146. The first gear 146 of the first gear assembly 142 defines one or more identifier notches 178 proximate the first set of peripheral teeth 162 to assist an assembler with locating the snap windows 156 and properly aligning the snap windows 156 with the snap feature 154 of the driver vane 140 of the first vertical vane pack 24. Furthermore, the first gear port 176 abuts an upper ledge 180 of the first gear 146 of the first gear assembly 142 from which the first set of peripheral teeth 162 extend, thereby inhibiting air 36 from escaping the first airway 34 through the first gear port 176. Thereafter, the second gear 148 of the first gear assembly 142 is pivotally coupled within a raised second gear port 182 of the housing 42 such that the second set of peripheral teeth 164 of the second gear 148 are interlocked with the first set of peripheral teeth 162 of the first gear 146. The second gear 148 of the first gear assembly 142 also defines an annular cavity 184 into which the raised second gear port 182 extends. Next, the thumb gear 150 of the first gear assembly 142 is pivotally received by a raised thumb gear pin 186 extending from the housing such that the thumb pad 174 faces toward the register opening 52, the pair of slots 170 of the thumb gear 150 receive the pair of stopper prongs 172 of the housing 42, respectively, and the fourth set of peripheral teeth 168 of the thumb gear 150 are interlocked with the third set of peripheral teeth 166 of the second gear 148.

The second gear assembly 144 may be assembled, installed on the housing 42, and operably coupled to the second vertical vane pack 28 using a similar assembly sequence as compared to the installment of the first gear assembly 142, as the housing 42 includes an additional raised first gear port 176, an additional raised second gear port 182, an additional raised thumb gear pin 186, and an additional pair of stopper prongs 172 proximate the second vertical vane pack 28. Notably, the raised first gear ports 176, the raised second gear ports 182, and the raised thumb gear pins 186 of the dual air vent assembly 10 provide robust bearing surfaces that enhance the operation of the first and second gear assemblies 142,144. In some configurations, the first gears 146 of the first and second gear assemblies 142, 144 do not include identifier notches 178.

The configuration of the first and second gear assemblies 142, 144 are configured to be more compact and lightweight as compared to known vane articulation assemblies of vehicle register systems. Furthermore, manufacturing of the first and second gear assemblies 142, 144 is simplified and may be expedited, as each of the first and second gear assemblies 142, 144 include identical or similar components. Either or both of the first and second gear assemblies 142, 144 may be electrically operated via one or more electrical actuators in electrical communication with a controller provided by the vehicle 11 (FIG. 17).

Referring to FIGS. 2, 5, 6, 9, and 12, an elongate pivot bracket 188 is disposed within each of the first and second airways 34, 38. The pivot brackets 188 extend along the upper retainer 12 and are pivotally coupled to each of the plurality of vanes 26 of the first and second vertical vane packs 24, 28, respectively. Regarding each of the first and second vertical vane packs 24, 28, when the driver vane 140 is pivoted between the first closed position 30 and the first fully articulated position 32, the pivot bracket 188 translates laterally, thereby uniformly pivoting all of the plurality of vertical vanes 26. Accordingly, the pivot bracket 188 controls the position, including the orientation, of each of the plurality of vertical vanes 26 so as to correspond with an instant position of the driver vane 140. It is contemplated that the pivot brackets 188 of the first and second airways 34, 38 may alternatively be disposed proximate the lower retainer 14.

With reference to FIGS. 2 and 17, when the first and second horizontal vane barrels 64, 66 are in the second closed position 100 (FIG. 8A), the outer horizontal vanes 118 substantially cover the register opening 52, thereby substantially blocking the flow of air 36 through the first and second airways 34, 38, respectively. Regarding each of the first and second horizontal vane barrels 64, 66, the lower edge 126 of the outer horizontal vane 118 defines an indent 190 proximate the center retainer 22, creating a gap interposing the lower retainer 14 and the lower edge 126 of the outer horizontal vane 118 at the indent 190. Accordingly, when the first and second horizontal vane barrels 64, 66 are in the second closed position 100, air 36 passing through the first and second airways 34, 38 is able to pass through the register opening 52. Consequently, the HVAC system of the vehicle 11 may heat or cool the interior compartment 39 before the user enters the interior compartment 39. According to some aspects, the HVAC system of the vehicle 11 may be configured to operate the dual air vent assembly 10 therein. It is contemplated that the indents 190 may be defined by the first and second horizontal vane barrels 64, 66 in alternative locations on the outer horizontal vanes 118. In some configurations, the first horizontal vane barrel 64 and/or the second horizontal vane barrel 66 do not define an indent 190.

Referring to FIGS. 2, 5, and 9, in each of the first and second airways 34, 38, the horizontal vane portion 62 of the lower retainer 14 includes an elongate rib 192. The elongate ribs 192 within the first and second airways 34, 38 protrude into the first and second airways 34, 38, respectively, from the lower retainer 14. As illustrated, the elongate ribs 192 protrude toward the upper retainer 12 and the register opening 52 and are spaced from the outer horizontal vanes 118 of the first and second horizontal vane barrels 64, 66 in the second fully articulated position 104. The elongate ribs 192 extend along the indents 190 of the first and second horizontal vane barrels 64, 66, respectively. The geometry of the elongate ribs 192 of the first and second airways 34, 38 substantially correspond with the gaps between the lower retainer 14 and the indents 190 of the first and second horizontal vane barrels 64, 66, respectively. Accordingly, when air 36 passes through the first and second airways 34, 38, the elongate ribs 192 are configured to deflect air 36 upwards toward rear surfaces 194 of the outer horizontal vanes 118 of the first and second horizontal vane barrels 64, 66, respectively, above the indents 190. Furthermore, when the first and second horizontal vane barrels 64, 66 are operated from the second closed position 100 to the second fully articulated position 104 or vice versa, the lower edges 126 of the outer horizontal vanes 118 therein at the indents 190 come into close proximity with the elongate ribs 192, respectively, effectively increasing the sealing of the first and second airways 34, 38 and maximizing airflow performance and control. In some instances, the elongate ribs 192 are not included in the configuration of the dual air vent assembly 10.

According to one exemplary assembly sequence of the dual air vent assembly 10, the lower retainer 14 is provided, and the left and right outboard retainers 18, 20 are snappingly coupled to the lower retainer 14. Next, the first and second horizontal vane barrels 64, 66 are pivotally coupled to the center retainer 22. The center retainer 22 is then together coupled to the lower retainer 14 while the first and second horizontal vane barrels 64, 66 are pivotally coupled to the left and right outboard retainers 18, 20. Thereafter, each of the first and second vertical vane packs 24, 28 are pivotally coupled to one of the pivot brackets 188, and each of the plurality of vertical vanes 26 of each of the first and second vertical vane packs 24, 28 are inserted into one of the plurality of pivot wells 16 of the lower retainer 14. The upper retainer 12 is then coupled to the center retainer 22 and the left and right outboard retainers 18, 20, and the plurality of pivot wells 16 defined by the upper retainer 12 each receive one of the plurality of vertical vanes 26, forming the air register 44. Here, each of the plurality of vertical vanes 26 of the first and second vertical vane packs 24, 28, except for the driver vanes 140, are inserted into the plurality of pivot wells 16 of the upper retainer 12. Notably, each of the center retainer 22 and the left and right outboard retainers 18, 20 include a plurality of locator prongs 196 configured to guide the upper and lower retainers 12, 14 into alignment with the center retainer 22 and the left and right outboard retainers 18, 20. When the upper and lower retainers 12, 14 are aligned with the center retainer 22 and the left and right outboard retainers 18, 20, the snap hooks 79a of each of the center retainer 22 and the left and right outboard retainers 18, 20 are receivable by the attachment ports 79b of the upper and lower retainers 12, 14. The air register 44 is then installed into the housing 42, after which the first and second gear assemblies 142, 144 are installed. The dual air vent assembly 10 may then be installed into the panel 40 of the vehicle 11 (FIG. 17).

With reference to FIGS. 1-17, the dual air vent assembly 10 advantageously has an enhanced robustness and a simplified manufacturing and assembly process compared to known vehicular air register systems, as the dual air vent assembly 10 includes an upper retainer 12 and a lower retainer 14 that each partially define both the first and second airways 34, 38. Both the upper and lower retainers 12, 14 may be installed simultaneously into the housing 42. The left and right outboard retainers 18, 20 and the center retainer 22 further increase robustness of the dual air vent assembly 10 and provide multiple functions pertaining to airflow control, pressure drop reduction, air shutoff, aerodynamics of the first and second airways 34, 38, functionality of other components, including the first and second vertical vane packs 24, 28 and the first and second horizontal vane barrels 64, 66, and overall performance of the dual air vent assembly 10. Additionally, the dual air vent assembly 10 has an enhanced compactness and requires fewer components than known air register systems, leading to increasingly efficient manufacturing and assembly of the dual air vent assembly 10, a reduction or elimination of manufacturing poka-yokes, and a reduction of manufacturing expenses. Furthermore, the aerodynamic characteristics of the components of the dual air vent assembly 10 enable a reduced pressure drop along the HVAC system which enhances HVAC system performance and energy consumption.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A dual air vent assembly for a vehicle, comprising:
an upper retainer;
a lower retainer spaced from and extending along the upper retainer, wherein each of the upper and lower retainers defines at least one pivot well;
a left outboard retainer extending between the upper and lower retainers;
a right outboard retainer extending between the upper and lower retainers;
a center retainer extending between the upper and lower retainers and centered between the left and right outboard retainers;
a first vertical vane pack disposed between the left outboard retainer and the center retainer;
a second vertical vane pack disposed between the right outboard retainer and the center retainer, wherein each of the first and second vertical vane packs includes a plurality of vertical vanes, wherein the plurality of vertical vanes of each of the first and second vertical vane packs are pivotal between a first closed position and a first fully articulated position, wherein the plurality of vertical vanes of the first vertical vane pack are independently pivotal relative to the plurality of vertical vanes of the second vertical vane pack, and wherein at least one of the plurality of vertical vanes of one of the first and second vertical vane packs is received by the at least one pivot well of each of the upper and lower retainers;
a first airway at least partially defined by the upper and lower retainers, the left outboard retainer, and the center retainer, wherein the first vertical vane pack is configured to laterally direct air passing through the first airway; and
a second airway at least partially defined by the upper and lower retainers, the right outboard retainer, and the center retainer, wherein the second vertical vane pack is configured to laterally direct air passing through the second airway.

2. The dual air vent assembly of claim 1, wherein the upper and lower retainers, the left and right outboard retainers, and the center retainer are contained in a housing.

3. The dual air vent assembly of claim 2, further comprising:
a first horizontal vane barrel pivotally coupled to the left outboard retainer and the center retainer adjacent to the first vertical vane pack; and
a second horizontal vane barrel pivotally coupled to the right outboard retainer and the center retainer adjacent to the first horizontal vane barrel, wherein each of the first and second horizontal vane barrels are pivotal between a second closed position and a second fully articulated position.

4. The dual air vent assembly of claim 1, wherein the center retainer defines a leading edge that divides an initial airway into the first airway and the second airway.

5. The dual air vent assembly of claim 3, wherein the first horizontal vane barrel is independently pivotal relative to the second horizontal vane barrel.

6. The dual air vent assembly of claim 1, wherein the first vertical vane pack is operably coupled to a first thumb gear, and wherein the second vertical vane pack is operably coupled to a second thumb gear.

7. The dual air vent assembly of claim 5, wherein the first horizontal vane barrel includes a first outer horizontal vane, and wherein the first outer horizontal vane extends between the upper and lower retainers and between the left outboard retainer and the center retainer in the second closed position, thereby substantially blocking airflow through the first airway.

8. The dual air vent assembly of claim 7, wherein the first horizontal vane barrel includes a first inner horizontal vane disposed between the first outer horizontal vane and the first vertical vane pack when the first horizontal vane barrel is in the second closed position, and wherein the first inner horizontal vane is smaller than the first outer horizontal vane.

9. The dual air vent assembly of claim 7, wherein the first outer horizontal vane defines an indent configured to enable air to pass through the first outer horizontal vane when the first horizontal vane barrel is in the second closed position.

10. An air vent assembly, comprising:
an upper retainer and a lower retainer spaced from the upper retainer;
a first outboard retainer and a second outboard retainer spaced from the first outboard retainer, wherein each of the first and second outboard retainers extends between the upper and lower retainers;
a center retainer extending between the upper and lower retainers and disposed between the first and second outboard retainers;
a first vertical vane pack disposed between the first outboard retainer and the center retainer, wherein the first vertical vane pack includes one or more vertical vanes pivotally coupled to both the upper and lower retainers; and
a second vertical vane pack disposed between the second outboard retainer and the center retainer, wherein the second vertical vane pack includes one or more vertical vanes pivotally coupled to both the upper and lower retainers, wherein at least one vertical vane of each of the first and second vertical vane packs is received by a first pivot well defined by the upper retainer and a second pivot well defined by the lower retainer, and wherein the second vertical vane pack is independently pivotal relative to the first vertical vane pack.

11. The air vent assembly of claim 10, wherein the first outboard retainer includes an outer wall extending between the upper and lower retainers and a body extending from the outer wall toward the center retainer.

12. The air vent assembly of claim 11, wherein the body defines an inner surface and a recessed surface that receives one of the one or more vertical vanes of the first vertical vane pack when the first vertical vane pack is in a fully articulated position.

13. The air vent assembly of claim 12, wherein a shutoff wall extends from the recessed surface, and wherein one of the plurality of vertical vanes of the first vertical vane pack is overlapped by the shutoff wall when the first vertical vane pack is in a closed position.

14. The air vent assembly of claim 13, wherein the inner surface of the body is obliquely angled relative to the outer wall, and wherein the inner surface is flush with one of the plurality of vertical vanes of the first vertical vane pack when the first vertical vane pack is in the fully articulated position.

15. The air vent assembly of claim 10, wherein the center retainer includes a first rib extending between the upper retainer and the lower retainer and protruding toward the first outboard retainer, and wherein one of the plurality of vertical vanes of the first vertical vane pack is configured to overlap the first rib when the first vertical vane pack is in a closed position.

16. An air register for a vehicle, comprising:
a first vertical vane pack;
a second vertical vane pack spaced from the first vertical vane pack, wherein each of the first and second vertical vane packs is pivotally coupled to an upper retainer and a lower retainer, and wherein the first vertical vane pack is independently pivotal relative to the second vertical vane pack;
a first horizontal vane assembly aligned with the first vertical vane pack and including a first outer horizontal vane configured to partially define a front register face and a first inner horizontal vane that is smaller than the first outer horizontal vane, wherein the first horizontal vane assembly is pivotal about a horizontal axis; and
a second horizontal vane assembly aligned with the second vertical vane pack and including a second outer horizontal vane configured to partially define the front register face and a second inner horizontal vane that is smaller than the second outer horizontal vane, wherein the second horizontal vane assembly is pivotal about the horizontal axis, and wherein the second horizontal vane assembly is independently pivotal relative to the first horizontal vane assembly.

17. The air register of claim 16, further comprising:
a first outboard retainer coupled to the upper and lower retainers; and
a center retainer spaced from the first outboard retainer and coupled to the upper and lower retainers, wherein the first horizontal vane assembly is pivotally coupled to the first outboard retainer and the center retainer.

18. The air register of claim 16, wherein the first vertical vane pack includes a plurality of vertical vanes, and wherein one or more vertical vanes of the first vertical vane pack defines a ridge that extends toward the first horizontal vane assembly.

19. The air register of claim 17, wherein the first outboard retainer includes a body extending toward the center retainer, and wherein the first outer horizontal vane of the first horizontal vane assembly is in close proximity to the body in a fully articulated position.

20. The air register of claim 19, wherein the first outer horizontal vane of the first horizontal vane assembly is adjacent to the ridge of the one or more vertical vanes of the first vertical vane pack when the first horizontal vane assembly is in the fully articulated position.
